(19) United States
(12) Patent Application Publication
(10) Pub. No.: US 2016/0257015 A1
(43) Pub. Date: Sep. 8, 2016

(54) CHOPPING DEVICE FOR CUTTING FOODSTUFFS, IN PARTICULAR FOR CUTTING GARLIC

(71) Applicant: GENIUS GMBH, Limburg (DE)

(72) Inventor: Cedomir Repac, Brechen (DE)

(21) Appl. No.: 14/639,252

(22) Filed: Mar. 5, 2015

(30) Foreign Application Priority Data
Mar. 5, 2015 (DE) 10 2015 103 222.8

(51) Int. Cl. B26D 3/18; A47J 19/04; B26D 3/26

(52) U.S. Cl. CPC B26D 3/185; B26D 3/26; A47J 19/04

(57) ABSTRACT

A chopping device for cutting foodstuffs such as garlic comprises a first housing part including a cutting grid, a second housing part including a pressing ram, and a threaded mechanism which moves the pressing ram relative to the cutting grid upon rotation of the first housing part in one direction relative to the second housing part. The chopping device has a changeover device which automatically switches the threads of the threaded mechanism into engagement irrespective of the axial position of the first housing part relative to the second housing part when the first housing part is rotated in the direction of rotation relative to the second housing part, and/or which automatically switches the threads out of engagement irrespective of the axial position of the first housing part relative to the second housing part when the first housing part is rotated in the counter direction relative to the second housing part.

### FIELD OF THE INVENTION

The invention relates to a chopping device for cutting foodstuffs, in particular for cutting garlic, comprising a first housing part and a second housing part, the first housing part comprising a cutting grid and the second housing part comprising a pressing ram, and comprising a threaded mechanism, by means of which, by rotation of the first housing part in one direction of rotation relative to the second housing part, the pressing ram is movable with respect to the cutting grid.

### BACKGROUND OF THE INVENTION

DE 198 39 704 C2 discloses a garlic cutter with a housing body which bears a knife. The garlic cutter has an upper part with a ram which is fastened thereto and, in the operating state, upon rotation relative to the housing body, carries out an axial movement counter to a co-rotating cutting grid, and with a cup-like inner body which receives the garlic, is mounted rotatably in the housing body and contains the cutting grid. The inner body is held in the housing body in a manner secured against dropping out by means of a snap-in or latching mechanism and is removable from the housing body counter to the action of the snap-in or latching mechanism for cleaning purposes.

DE 199 48 168 C1 discloses an apparatus for cutting garlic, onions or similar vegetables. The apparatus has an inner part which has a receiving space with a cutting grid, which is arranged at one end, for the material to be cut. In addition, the apparatus has a housing upper part which has a ram and with which the receiving space can be closed at the other end. Furthermore, the apparatus comprises a housing body which has a knife and in which the inner part is accommodated in a rotatable manner, and threaded means which, as a result of a rotation of the housing upper part, allow the ram to move into the receiving space of the co-rotating inner part or to move out therefrom. The threaded means can be brought into engagement or out of engagement by means of adjustment means, wherein the adjustment means is arranged in an axially displaceable manner on the housing upper part and, in a first axial position, brings the threaded means into engagement and, in a second, different axial position, brings the threaded means out of engagement.

DE 198 05 933 C1 discloses a garlic cutter comprising a housing body which bears a knife on the lower side thereof, and comprising an upper part with a ram which is fastened thereto and, in the operating state, upon rotation in relation to the housing body, executes an axial movement counter to a co-rotating cutting grid. The garlic cutter comprises an inner body which receives the garlic and is mounted rotatably in the housing body, which has a cutting grid and into which the ram, which is arranged on a spindle, enters. In addition, means are provided, in particular a union nut which can be mounted onto the housing body, which means, in the operating state, ensure the engagement in the spindle and, in the open state, permit a longitudinal displacement of the spindle.

DE 102 23 075 B4 discloses a vegetable cutter comprising a housing lower part which bears a knife on the lower side thereof and accommodates a rotatable inner body with a cutting grid. The inner body is fillable with the vegetable, in particular garlic. The vegetable cutter has a housing upper part with a ram which is arranged on a spindle and, in the operating state, enters the inner body and, upon rotation of the housing upper part relative to the housing lower part, executes an axial movement counter to the cutting apparatus. The vegetable cutter also has means which, in the operating state, ensure engagement in a thread of the spindle and, in the open state, permit a free axial displacement of the spindle or of the ram, wherein the means are connected to the housing upper part and also the spindle is guided in an axially displaceable manner on the housing upper part and is acted upon by a pretensioning of a spring.

In the case of chopping devices in which the material to be chopped is pressed against a cutting grid by means of a pressing ram, which is driven by a threaded mechanism, there is the problem that, prior to the actual cutting operation, the user has to bring about a multiplicity of rotations before the pressing ram reaches the material to be chopped at all. After the material which is to be chopped has been pushed through the cutting grid, the user then has to completely rotate the threaded mechanism back again in order to be able to fill the chopping device again with cutting material.

For this reason, in the case of all of the above mentioned chopping devices known from the prior art, the possibility is provided of disconnecting the threaded mechanism in order to be able to execute a free axial displacement of the pressing ram relative to the cutting grid. However, in the case of the previously known chopping devices, for this purpose a changeover switch, such as, for example, an axially displaceable changeover ring, has to be operated separately.

### SUMMARY OF THE INVENTION

It is therefore the object of the present invention to provide a chopping device which can be operated even more simply.

The object is achieved by a chopping device of the type mentioned at the beginning, wherein the chopping device has a changeover device which
a. automatically switches the threads of the threaded mechanism into engagement irrespective of the axial relative position of the first housing part relative to the second housing part when the first housing part is rotated in the direction of rotation relative to the second housing part, and/or which
b. automatically switches the threads of the threaded mechanism out of engagement irrespective of the axial relative position of the first housing part relative to the second housing part when the first housing part is rotated in the counter direction of rotation, which is opposed to the direction of rotation, relative to the second housing part.

It has been recognized according to the invention that a changeover switch which is to be operated separately and with which the user can change over between an engaged position and a disengaged position does not necessarily have to be present. On the contrary, after changing over from the disengaged position into the engaged position, the requirement can be inherently concluded from the fact that the user exactly undertakes the rotational operation which is necessary in order to move the pressing ram in the direction of the cutting grid by means of the threaded mechanism. In this respect, the chopping device according to the invention has the very particular advantage that the user, after inserting the material to be cut into a cutting material receptacle, merely needs to bring the pressing ram in the axial direction against the inserted material, when the threaded mechanism is disengaged, and then immediately, and without having to operate an additional changeover switch, can begin with the rotational operation which is necessary in order to move the pressing ram forward in the direction of the cutting grid by means of the threaded mechanism. The changing over from the disengaged position into the engaged position takes place automatically here.

Alternatively or additionally, this principle can advantageously also be realized in order to be able to remove the pressing ram again from the cutting material receptacle rapidly and efficiently after a cutting operation. Also in this regard, after changing over from the engaged position into the disengaged position, the requirement can be recognized from the fact that the user exactly initiates the counter-rotational operation which would be necessary in order to move the pressing ram away from the cutting grid by means of the threaded mechanism. In this connection, it can advantageously be provided that, even after a short rotational distance is executed, for example a sixth of a rotation, a changeover from the engaged position into the disengaged position automatically takes place, and therefore the user can pull the pressing ram freely out of the cutting material receptacle.

In a particular embodiment, a plurality of threaded segments which are distributed in the circumferential direction and are held in a radially movable manner are arranged in the second housing part. In particular, a plurality of threaded segments which are distributed in the circumferential direction and are in each case mounted in a manner movable radially, in particular inward, counter to a spring force can be arranged in the second housing part.

In a particularly advantageous embodiment, a plurality of spring tongues which are distributed in the circumferential direction and each have a threaded segment are arranged in the second housing part, the threaded segments of which spring tongues can be moved radially inward in a spring-elastic manner. Alternatively or additionally, it can also be provided that a plurality of spring tongues which are distributed in the circumferential direction and each have a threaded segment are arranged in the second housing part, the free ends of which spring tongues are movable radially inward in a spring-elastic manner. In particular in such an embodiment, it is advantageous if the threaded segments are arranged at the free end of the spring tongue.

In an advantageous manner, the changeover device can have a plurality of run-on slopes which move the threaded segments radially inward when the first housing part is rotated in the direction of rotation relative to the second housing part. Alternatively or additionally, it can also be provided that the changeover device has a plurality of run-on slopes which enable a movement of the threaded segments radially outward when the first housing part is rotated in the counter direction of rotation.

For example, the run-on slopes can be arranged on a changeover ring or can be jointly produced integrally with a changeover ring. In an advantageous embodiment, the run-on slopes are arranged on a changeover ring which is connected to the second housing part for rotation therewith, at least with respect to torques in the axial direction, and/or which is mounted in the second housing part for rotation therewith. In order to bring about a changeover, the run-on slopes and/or the changeover ring do not have to be accessible from the outside since the changeover ring does not act as a changeover switch which is to be actuated separately.

In this respect, it can be advantageously provided that the run-on slopes are connected to the second housing part for rotation therewith, at least with respect to torques which act in the axial direction, and/or that the run-on slopes are arranged within the second housing part.

In an advantageous embodiment, the threaded segments are mounted within the second housing part so as to be rotatable within a limited angular range, in particular within an angular range of 45 degrees or of 30 degrees. In particular, it can advantageously be provided that the threaded segments are arranged within a cage for rotation therewith, said cage being mounted within the second housing part so as to be rotatable within a limited angular range, in particular within an angular range of 45 degrees or of 30 degrees.

The rotatability of the threaded segments relative to the second housing part by a limited angle serves to change over the threaded mechanism from the engaged position into the disengaged position, or conversely from the disengaged position into the engaged position, depending in each case on the direction of rotation. After a changeover operation, the threaded segments enter into a rotational stop with the second housing part, for example via a cage to which said threaded segments are fastened. After a changeover operation from the disengaged position into the engaged position, the pressing ram can be moved in the direction of the cutting grid by continuation of the rotational movement by means of the threaded mechanism.

In a particular embodiment, the threaded segments and/or the spring tongues are directly or indirectly connected to the pressing ram for rotation therewith, at least with respect to torques which act in the axial direction. If the pressing ram is additionally rotatable, which is explained in detail further below, relative to the second housing part, at least within a limited angular range, a relative rotation of the pressing ram and of the threaded segments connected thereto relative to the second housing part can be used in order to move the threaded segments radially, for example with the aid of the run-on slopes, and, depending on the direction of rotation of the relative rotation, to bring said threaded segments into engagement with or out of engagement from the mating thread of the threaded mechanism.

In a very particularly advantageous embodiment, the cage to which the pressing ram is connected for rotation therewith has a plurality of recesses, which are distributed in the circumferential direction, for the threaded segments and/or the spring tongues. In particular, it can advantageously be provided that the cage has a plurality of recesses which are distributed in the circumferential direction and in which the threaded segments and/or the free ends of the spring tongues are arranged in a radially movable manner. The recesses have the advantage that the spring tongues are guided in the tangential direction. This has an advantageous effect in particular if tangential forces act on the threaded segments and/or the spring tongues; for example, if, during a cutting operation, the second housing part is rotated relative to the first housing part, and the threaded segments slide along the mating thread.

In particular, the threaded segments and/or the spring tongues can be connected to the cage for rotation therewith with respect to torques in the axial direction. A simple connection to the pressing ram for rotation therewith can thereby advantageously be produced via the cage. In particular, it can advantageously be provided that each spring tongue is connected at one of the ends thereof fixedly to the cage while the other end, which can in particular have the threaded segment, is movable radially relative to the cage. The rotationally fixed connection can be produced, for example, by one end of the spring tongue being introduced in a form-fitting manner into a receptacle of the cage.

In a particularly advantageous embodiment, the pressing ram and/or the cage are connected to a holding ring, which is in particular accessible from the outside, for rotation therewith. As is also explained in detail further below, the rotational resistance to the rotation of the pressing ram can be increased with the aid of the holding ring by the user securing the holding ring from the outside. This is advantageous in particular whenever the rotational resistance to the rotation of the pressing ram is lower than the rotational resistance to the changing over of the threaded mechanism from the engaged position into the disengaged position or from the disengaged position into the engaged position, for example because precisely no cutting material is inserted into the cutting material receptacle and/or before the second housing part is placed onto the first housing part and/or before the pressing ram is introduced into the cutting material receptacle.

For example, it can advantageously be provided that the cage is of cylindrical design, with the holding ring being fastened on one end of the cage and the pressing ram and/or the spring tongues being fastened to the other end. Such an embodiment is, firstly, especially compact and, furthermore, is especially functional because the cage supports and connects together a plurality of components in an advantageous manner.

As already explained, it can advantageously be provided that the threaded segments in the engaged position of the threaded mechanism are in engagement with a mating thread of the threaded mechanism and in the disengaged position of the threaded mechanism are at a distance from the mating thread of the threaded mechanism. As likewise already explained, the chopping device can be designed in such a manner that the threaded segments can be moved radially with the aid of run-on slopes and can therefore be brought into engagement with the mating thread as soon as the first housing part is rotated in the direction of rotation relative to the second housing part. Analogously, it can advantageously be provided that the threaded segments move away radially again from the mating thread and therefore become disengaged, in particular by means of spring force, as soon as the first housing part is rotated in the counter direction of rotation, which is opposed to the direction of rotation, relative to the second housing part.

For example, the first housing part can have the mating thread of the threaded mechanism. In particular, it can advantageously be provided that the first housing part has the mating thread which is arranged on the outer side of the first housing part and is designed as an external thread. In a particular embodiment in which the threaded segments are arranged within the second housing part, after the material to be cut is inserted into a cutting material receptacle which is arranged within the first housing part, the second housing part is pulled over the first housing part, with the threaded mechanism disengaged, until the pressing ram comes into contact with the material to be cut. Subsequently, the second housing part is rotated relative to the first housing part, as a result of which the threads of the threaded mechanism are automatically switched into engagement irrespective of the axial relative position of the first housing part relative to the second housing part that is then present, and the pressing ram is then moved in the direction of the cutting grid by the threaded mechanism.

In an advantageous embodiment, the chopping device has a cutting material receptacle which is mounted rotatably in the first housing part and into which the pressing ram can be introduced. In particular, it can advantageously be provided that the cutting material receptacle has an opening for the pressing ram opposite the cutting grid.

The cutting grid can be fastened, in particular so as to be releasable again, to the cutting material receptacle. The cutting grid can be fastened to the cutting material receptacle, for example, by a latching connection or a quarter-turn connection. Such an embodiment has the particular advantage that the cutting grid can be removed for a cleaning operation and can be cleaned more simply. However, it is also possible for the cutting grid to be fastened fixedly to the cutting material receptacle. Such an embodiment can be produced particularly cost-effectively.

In order to ensure that the pressing ram transmits the rotational movement thereof to the cutting material receptacle and the co-rotating cutting grid, it can advantageously be provided that the pressing ram has an outer contour deviating from the circular shape in a cross section perpendicular to the axial direction, and the cutting material receptacle has a complementary inner contour in a cross section perpendicular to the axial direction.

In a very particularly advantageous embodiment and according to an independent inventive concept which can also be used irrespective of whether the threaded mechanism can be switched freely or not, it is provided that the pressing ram, at the free end thereof, has a plurality of pressing projections which can be introduced into the intermediate spaces between the blades of the cutting grid, and that a cleaning grid is mounted between the pressing projections so as to be axially displaceable counter to the force of a spring device, said cleaning grid having at least one stop which projects radially beyond the outer contour of the pressing ram, strikes against a counter stop of the cutting material receptacle and keeps the cleaning grid at a distance from the blades of the cutting grid when the pressing projections enter the intermediate spaces between the cutting blades of the cutting grid. It is thereby advantageously ensured that the cutting blades of the cutting grid do not damage the cleaning grid and that the cutting blades are not blunted by repeated striking against the cleaning grid.

In a very particularly advantageous embodiment, the rotational resistance for switching over from the engaged position of the threaded mechanism into the disengaged position and/or the rotational resistance for switching over from the disengaged position of the threaded mechanism into the engaged position is smaller than the rotational resistance for rotating the cutting material receptacle relative to the first housing part. This can be realized, for example, in such a manner that the threaded segments and/or the spring tongues, which are connected to the pressing ram for rotation, the pressing ram, in turn, engaging in the rotatably arranged cutting material receptacle for rotation therewith, are braked relative to the second housing part by the friction of the cutting material receptacle on the first housing part in such a manner that they can be moved radially by means of the run-on slopes, which are connected to the second housing part for rotation therewith, without deviating tangentially. As already mentioned, there can advantageously be a holding ring or a similar component in order to be able to fixedly hold the threaded segments and/or the spring tongues relative to the second housing part so as then also to be able to bring about a changing over operation if the rotational resistance of the threaded segments and of the components connected in terms of rotation thereto is too low, for example because the second housing part has not yet even been placed onto the first housing part and/or because the pressing ram has not yet been introduced into the cutting material receptacle.

By means of the cutting material being pushed through the co-rotating cutting grid, the cutting material is cut into rods. In an advantageous manner the first housing part can have, adjacent to the cutting grid, a radially oriented, non-co-rotating severing blade which extends over half of the opening cross section of the cutting grid. The severing blade serves to sever cubes from the rods. In particular, it can advantageously be provided that the severed cubes drop into a collecting container which is arranged below the cutting grid and below the severing blade. Then very generally, a collecting container which can be fixed on the first housing part and/or which can be at least partially introduced into the first housing part can advantageously be provided.

### BRIEF DESCRIPTION OF THE DRAWING VIEWS

The inventive subject matter is illustrated by way of example and schematically in the drawing and is described below with reference to the figures, wherein elements which are identical or act in an identical manner are mostly provided with the same reference signs. In the figures:

FIG. 1 shows an exemplary embodiment of a chopping device according to the invention in an insertion position,

FIG. 2 shows the exemplary embodiment of the chopping device according to the invention after the first housing part and the second housing part are joined together,

FIG. 3 shows the exemplary embodiment of the chopping device according to the invention after the cutting operation,

FIG. 4 shows a detailed illustration of the exemplary embodiment,

FIG. 5 shows an exploded illustration which reveals some of the components arranged in the second housing part,

FIG. 6 shows an exploded illustration of the exemplary embodiment of the chopping device according to the invention,

FIG. 7 shows a perspective illustration of the first and the second housing part,

FIG. 8 shows a longitudinal sectional illustration in the engaged position,

FIG. 9 shows a cross-sectional illustration in the engaged position,

FIG. 10 shows a longitudinal sectional illustration in the disengaged position,

FIG. 11 shows a cross-sectional illustration in the disengaged position,

FIG. 12 shows a view from below,

FIG. 13 shows a longitudinal sectional illustration for explaining the cleaning function of the pressing projections of the pressing ram, and

FIG. 14 shows a detailed illustration of the cutting material receptacle.

### DETAILED DESCRIPTION OF THE INVENTION

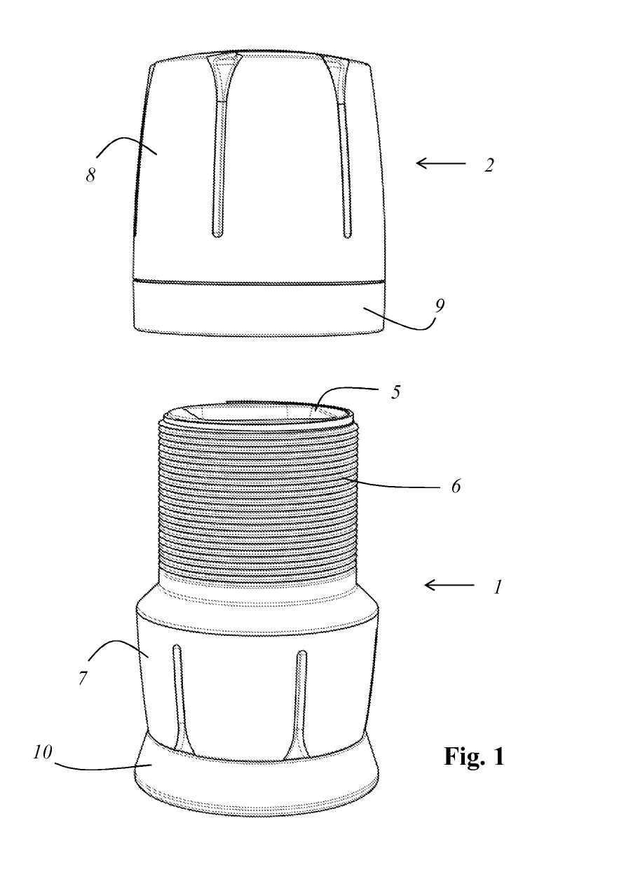

FIG. 1 shows a chopping device for cutting foodstuffs, in particular for cutting garlic, comprising a first housing part 1 and a second housing part 2, wherein the first housing part 1 comprises a cutting grid 3, which is not visible in this figure, and the second housing part comprises a pressing ram 4, which is not visible in this figure. The chopping device has a threaded mechanism, by means of which, by rotation of the first housing part 1 in one direction of rotation relative to the second housing part 2, the pressing ram 4 is movable with respect to the cutting grid 3. As part of the threaded mechanism, the first housing part 1 has an external thread 6.

In addition, the first housing part 1 has a first gripping section 7, at which the first housing part 1 can be held. Furthermore, the second housing part 2 has a second gripping section 8, at which the second housing part 2 can be held. In addition, a holding ring 9, the function of which is described further below, is located on the second housing part 2.

The chopping device has a changeover device which automatically switches the threads of the threaded mechanism into engagement irrespective of the axial relative position of the first housing part 1 relative to the second housing part 2 when the first housing part 1 is rotated in the direction of rotation relative to the second housing part 2, and which automatically switches the threads of the threaded mechanism out of engagement irrespective of the axial relative position of the first housing part 1 relative to the second housing part 2 when the first housing part 1 is rotated in the counter direction of rotation, which is opposed to the direction of rotation, relative to the second housing part 2.

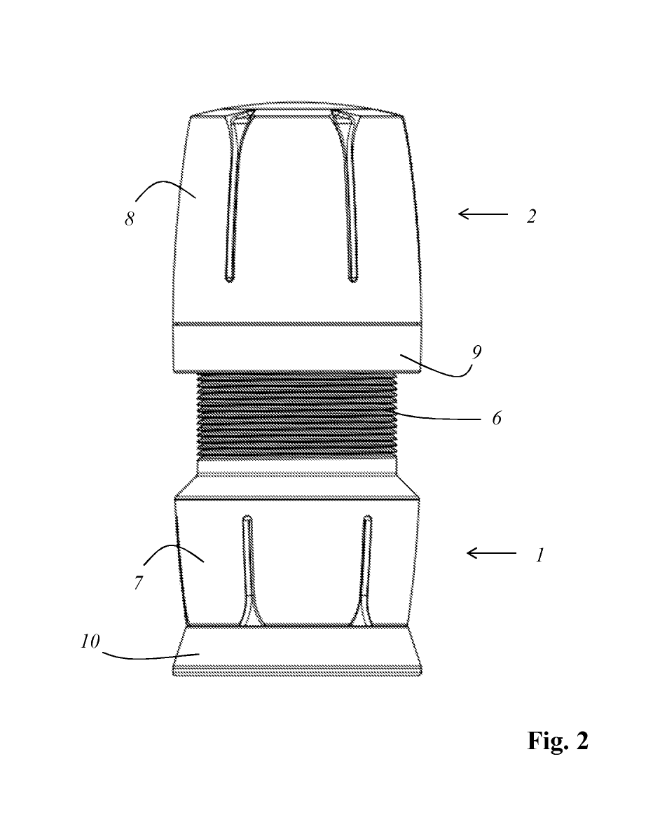

A cutting material receptacle 5 is mounted rotatably in the first housing part 1. In the shown position of the first housing part 1 and of the second housing part 2, cutting material, for example garlic, can be inserted from above into the cutting material receptacle 5 through an opening. The first housing part 1 is subsequently placed onto the second housing part 2, wherein the changeover device is in the disengaged position, and wherein the pressing ram 4 (not visible in this figure) which is arranged in the second housing part 2 is introduced axially into the opening in the cutting material receptacle 5 until said pressing ram is placed onto the cutting material. This situation is illustrated in FIG. 2.

The user can now immediately, and without having to operate an additional changeover switch, begin with the rotational operation which is necessary in order to move the pressing ram 4 forward in the direction of the cutting grid 3 by means of the threaded mechanism. In this connection, the second housing part 2 is rotated in the clockwise direction relative to the first housing part 1. By means of initiation of the rotational operation, the threaded mechanism is automatically switched over from the disengaged position into the engaged position.

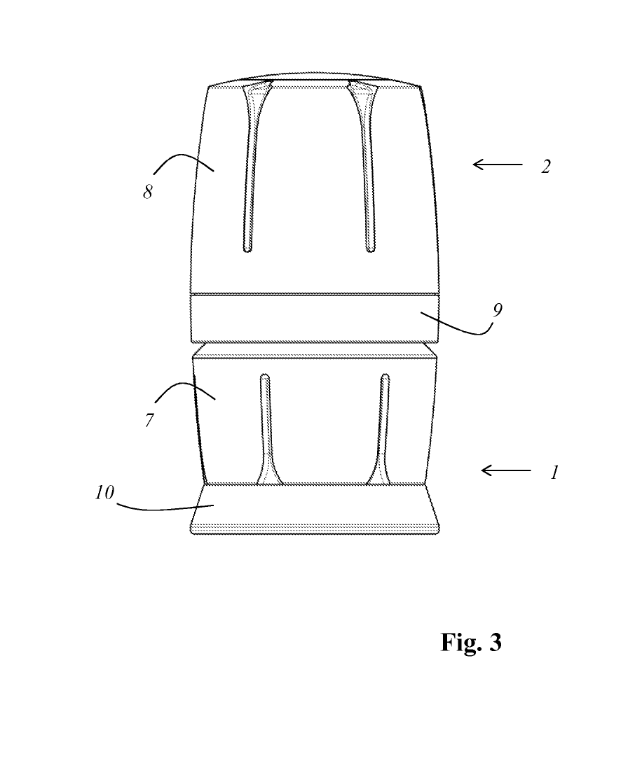

The user continues the rotational operation until all of the cutting material is pushed through the cutting grid 3; namely until the pressing ram 4 has reached the cutting grid 3. This situation is illustrated in FIG. 3.

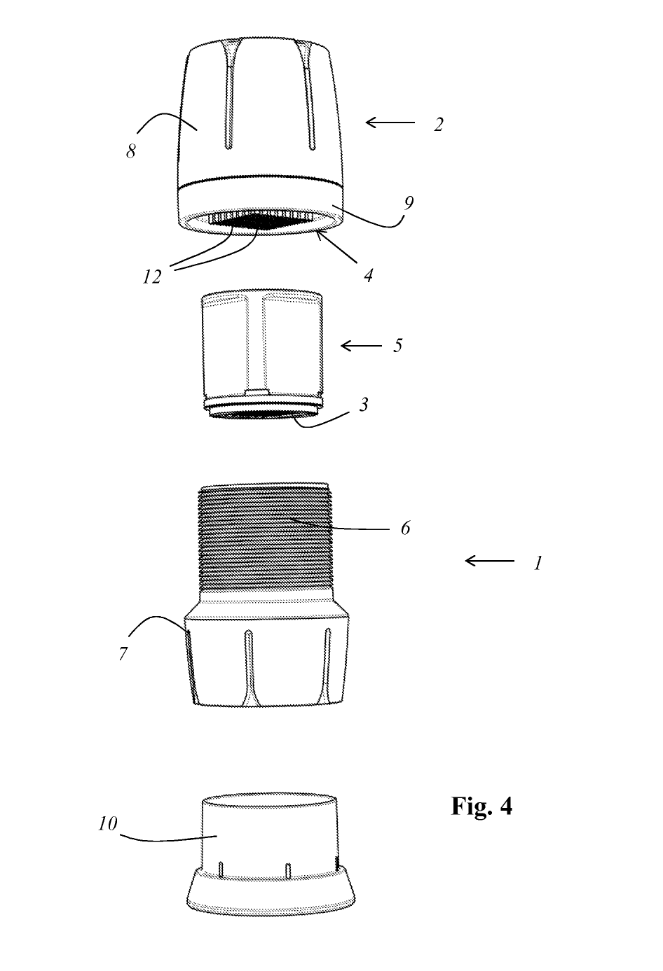

FIG. 4 shows a detailed illustration of the chopping device, which illustration in particular reveals the first housing part 1 and the cutting material receptacle 5, which is mounted rotatably in the first housing part. The cutting grid 3 is fastened to the cutting material receptacle 5 on the side facing away from the opening.

In addition, the chopping device has a collecting container 10 which can be pushed into the first housing part 1 from below and which collects the cubes which are pushed through the cutting grid 3 and are severed by a severing blade 11, which is not visible in this figure.

The pressing ram 4 has, at the free end thereof, pressing projections 12 which, toward the end of the cutting operation, enter the intermediate spaces between the cutting blades 13 of the cutting grid 3.

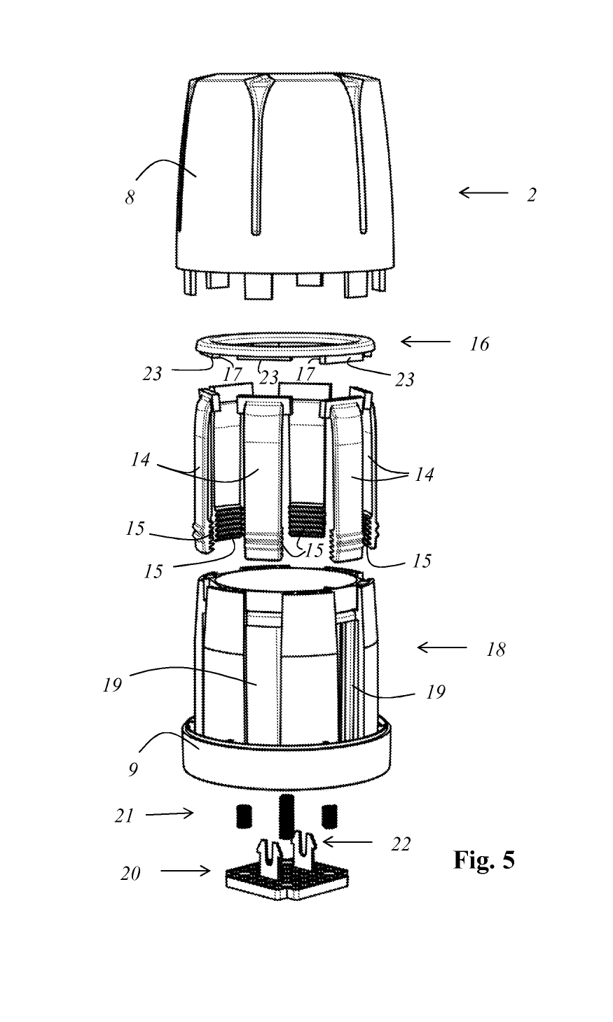

FIG. 5 shows an exploded illustration which reveals some of the components arranged in the second housing part 2. For the sake of better clarity, the pressing ram 4 is not illustrated in this figure.

A plurality of spring tongues 14 which are distributed in the circumferential direction and each have a threaded segment 15 are arranged in the second housing part 2 in a rotationally fixed manner with respect to the pressing ram 4 (not illustrated), the threaded segments 15 of which spring tongues can be moved radially inward in a spring-elastic manner.

In order to move the spring tongues 14 radially inward, run-on slopes 17 are arranged on a changeover ring 16 in a manner oriented slightly obliquely with respect to the tangential direction. The changeover ring 16 is arranged in the second housing part 2 for rotation therewith. If the changeover ring 16 is rotated in the direction of rotation relative to the spring tongues 14, the free ends thereof are pushed radially inward by the run-on slopes 17 in order to enter into engagement with the external thread 6. If the changeover ring 16 is rotated in the counter direction of rotation, the spring tongues 14 are released again and move radially outward in order to release the threaded mechanism, and therefore the second housing part 2 can be moved freely axially again relative to the first housing part 1.

The pressing ram 4 is arranged in a rotationally fixed and coaxial manner within a cage 18 which is mounted within the second housing part 2 so as to be rotatable within a defined angular range, in particular within an angular range of 45 degrees or of 30 degrees.

The cage 18 has a plurality of recesses 19, which are distributed in the circumferential direction, for the spring tongues 14. The spring tongues 14 are arranged in the recesses 19 in such a manner that the free ends thereof are movable radially. The upper ends of the spring tongues 14 are fastened immovably to the cage 18. In addition, the holding ring 9 is fastened to the cage 18 for rotation therewith.

As already mentioned, the pressing ram 4 (not illustrated in FIG. 5) has, at the free end thereof, a plurality of pressing projections 12 which can be introduced into the intermediate spaces between the cutting blades 13 of the cutting grid 3. Furthermore, a cleaning grid 20 is mounted between the pressing projections (not illustrated in FIG. 5) so as to be displaceable axially counter to the force of a spring device 21. The spring device 21 pushes the cleaning grid 20 onto the free end of the pressing ram 4, and therefore the latter ends flush with the pressing projections 12. A latching device 22 prevents the cleaning grid 20 from being pushed downward from the pressing ram 4.

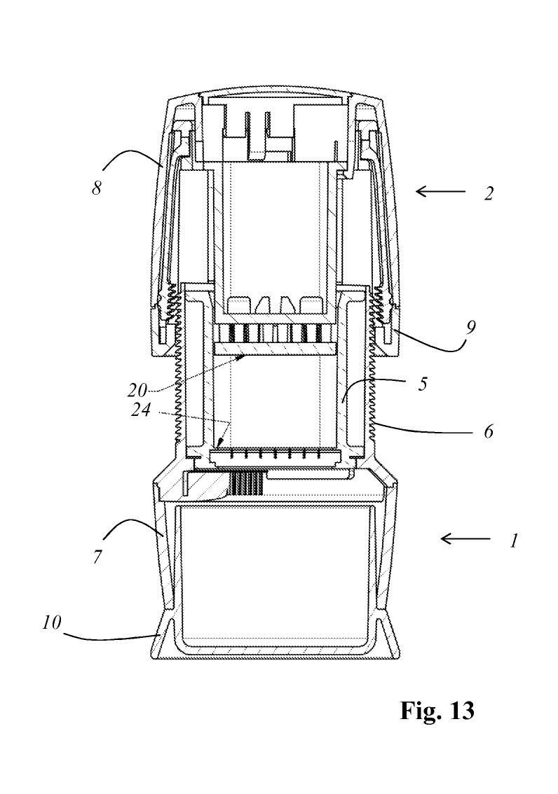

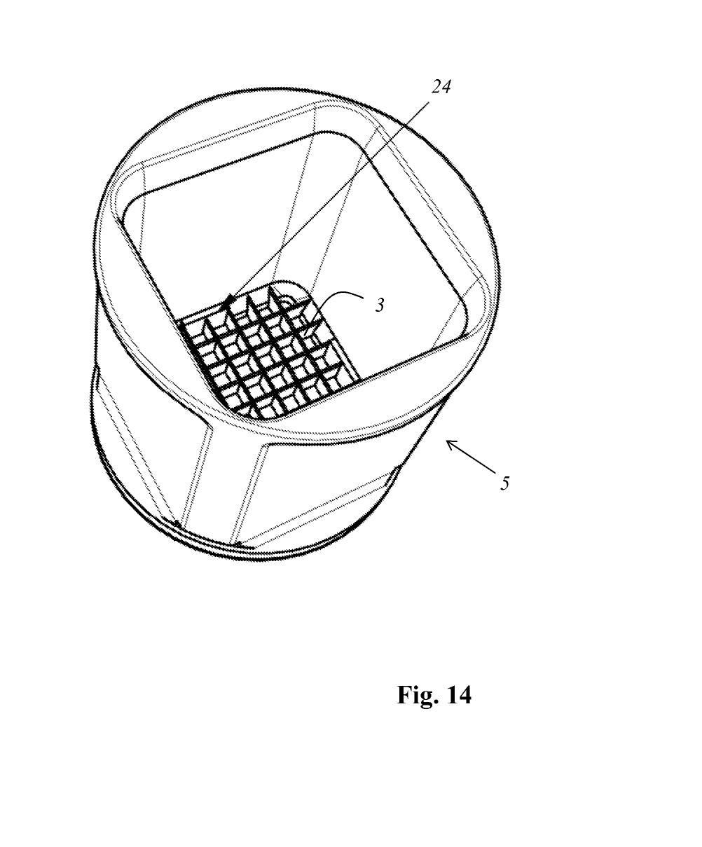

The cleaning grid 20 has a plurality of stops which project radially beyond the outer contour of the pressing ram 4, strike against mating stops 24 of the cutting material receptacle 5 and keep the cleaning grid 20 at a distance from the cutting blades of the cutting grid 3 when the pressing projections 12 enter the intermediate spaces between the cutting blades of the cutting grid 3. This can be clearly seen in particular in FIGS. 13 and 14.

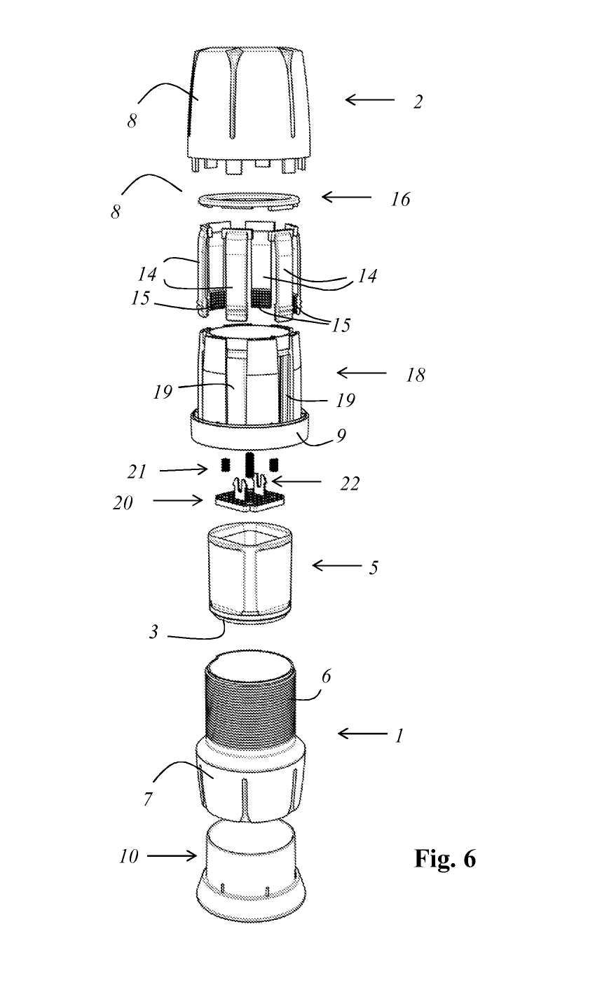

FIG. 6 shows an exploded illustration of the exemplary embodiment of the chopping device according to the invention.

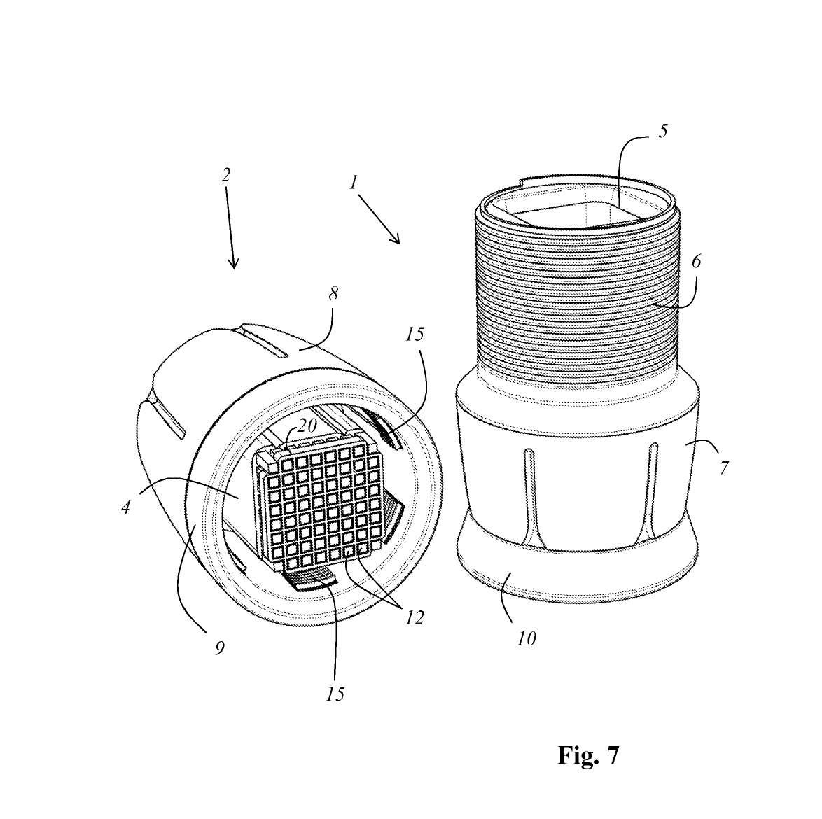

In order to ensure that the pressing ram 4 transmits the rotational movement thereof to the cutting material receptacle 5 and the co-rotating cutting grid 3, the pressing ram 4 has an outer contour deviating from the circular shape, in a cross section perpendicular to the axial direction, namely a square outer contour, which can be clearly seen in particular in FIG. 7. In a corresponding manner, the cutting material receptacle 5 has a complementary inner contour in a cross section perpendicular to the axial direction.

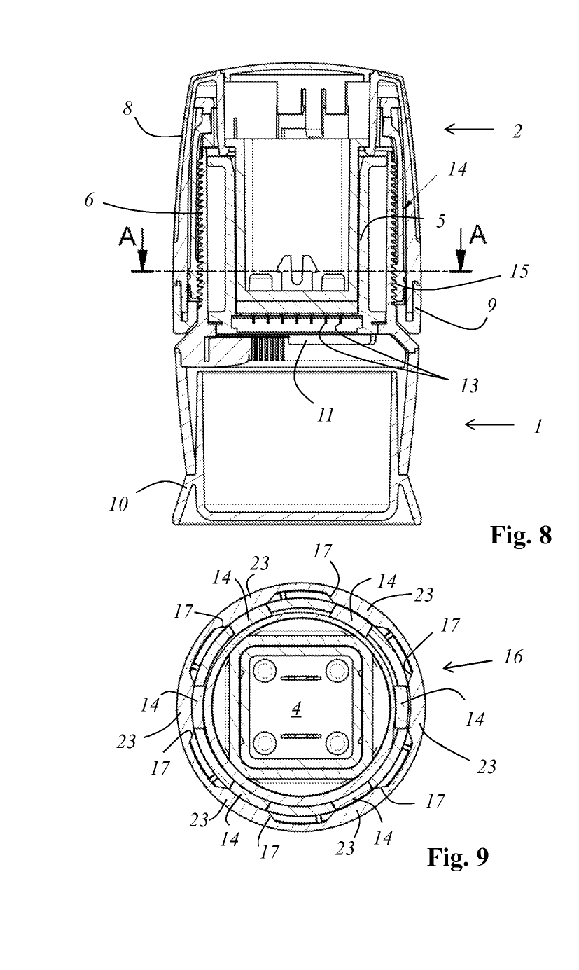

FIG. 8 shows a longitudinal sectional illustration of the exemplary embodiment of the chopping device according to the invention in an engaged position of the threaded mechanism. It can be seen that, in this engaged position, the threaded segments 15 of the spring tongues 14 engage in the external thread 6, and therefore the pressing ram 4 can be moved in the direction of the cutting grid 3 by rotation of the second housing part 2 relative to the first housing part 1.

FIG. 8 also shows the radially oriented severing blade 11. The cutting material is cut into rods by the cutting material being pushed through the co-rotating cutting grid 3. By means of the non-co-rotating severing blade 11, which is arranged adjacent to the cutting grid 3, cubes are severed from the rods and drop into the collecting container 10.

FIG. 9 shows a cross-sectional illustration along the intersecting line A-A plotted in FIG. 8. It can be seen that the changeover ring 16 has inwardly directed projections 23 with the run-on slopes 17 formed thereon. In the position illustrated in FIG. 9, the projections 23 hold the free ends of the spring tongues 14 in a radially inwardly displaced position. In this engaged position, the threaded segments 15 are in engagement with the external thread 6.

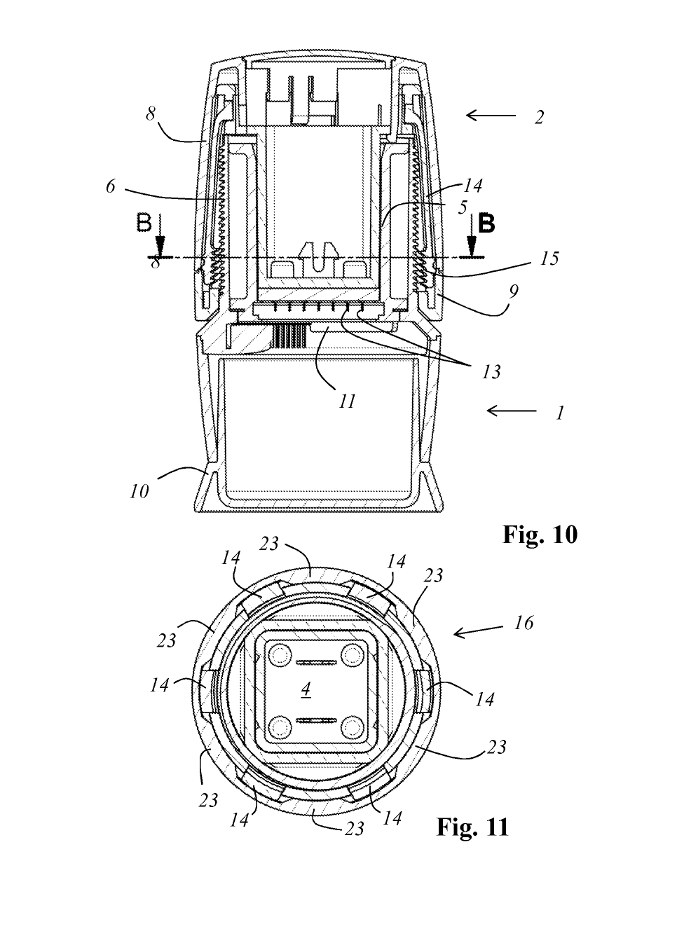

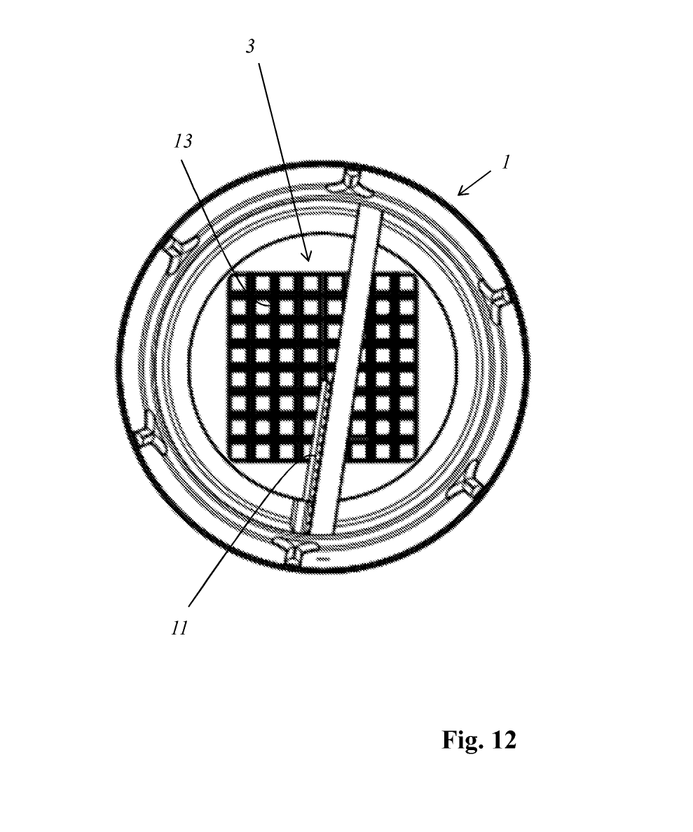

FIG. 10 shows a longitudinal sectional illustration of the exemplary embodiment of the chopping device according to the invention in a disengaged position of the threaded mechanism. In this position, the free ends of the spring tongues 14 are displaced radially outward, and therefore said ends do not engage in the external thread 6. As FIG. 11 shows, in the disengaged position, the free ends of the spring tongues 14 are arranged displaced radially outward between the projections 23 of the changeover ring 16.

In particular when cutting material is inserted into the cutting material receptacle 5 and the pressing ram 4 is in contact with the cutting material, as a result of which the cutting material receptacle 5 is pushed against the first housing part 1 and, upon rotation, slides on the first housing part 1 with friction, the rotational resistance for changing over the threaded mechanism is smaller than the rotational resistance for rotating the cutting material receptacle 5 relative to the first housing part 1. The spring tongues 14, which are connected via the cage 18 to the pressing ram 4 for rotation therewith, said pressing ram in turn engaging in the rotatably arranged cutting material receptacle 5 for rotation therewith, are braked by the friction of the cutting material receptacle 5 in such a manner that they can be moved radially by means of the projections 23, which have the run-on slopes 17 and which are connected to the second housing part 2 for rotation therewith, without deviating tangentially.

The holding ring 9 serves to be able to secure the spring tongues 14 relative to the second housing part 2 in order also to be able to bring about a changeover operation when the rotational resistance of the threaded segments 15 and of the components rotationally connected thereto is too low, for example because precisely no cutting material has been inserted into the cutting material receptacle or because the second housing part 2 has not yet even been placed onto the first housing part 1 or because the pressing ram 4 has not yet been introduced into the cutting material receptacle 5. Without manual securing, in such a situation the spring tongues 14 would be rotated at the same time by the projections 23 without a radial displacement of the threaded segments 15 and a changing over of the threaded mechanism taking place.

Should the threaded segments 15 be in a radially inwardly displaced position before the second housing part 2 is placed onto the first housing part 1, the user should firstly, in order to be able to achieve free axial displaceability, bring about a relative rotation of the second housing part 2 together with the changeover ring 16, which is connected thereto for rotation therewith, relative to the holding ring 9 and therefore relative to the threaded segments 15 in order to release the threaded segments 15 so that they can swing radially outward.

After cutting material has been inserted into the cutting material receptacle 5 and the pressing ram 4, which is arranged in the second housing part 2, is introduced axially into the cutting material receptacle 5 and is brought in the contact with the cutting material, the first housing part 1 can be rotated in the clockwise direction relative to the second housing part 2. In this connection, first of all only the second housing part 2 rotates by a limited angle relative to the cage 18 and the spring tongues 14, as a result of which the spring tongues 14 are displaced inward radially by means of the run-on slopes 17 of the changeover ring 16, which is connected to the second housing part 2 for rotation therewith, and thus enter into engagement with the external thread 6. Subsequently, the second housing part 2 passes into a rotational stop with the cage 18, and therefore, when the rotational movement is continued, the cage 18 together with the pressing ram 4, which is fastened thereto, and with the cutting material receptacle 5, into which the pressing ram 4 projects, is then also rotated at the same time. The rotation of the second housing part 2 relative to the first housing part 1 causes the threaded mechanism to advance the pressing ram 4 in the direction toward the cutting grid 3 and therefore the cutting material is pushed through the cutting grid 3.

After the cutting operation, the user merely has to rotate the second housing part 2 in the opposite direction, i.e. counterclockwise, as a result of which the spring tongues 14 are released radially and swing away radially outward from the external thread 6. The threaded mechanism is released in this position, and therefore the pressing ram 4 can easily be pulled axially out of the cutting material receptacle 5.

### LIST OF REFERENCE SIGNS

first housing part
second housing part
cutting grid
pressing ram
cutting material receptacle
external thread
first gripping part
second gripping part
holding ring
collecting container
severing blade
pressing projections
cutting blades
spring tongues
threaded segments
changeover ring
run-on slopes
cage
recesses
cleaning grid
spring device
latching device
projections
counter stops

1. A chopping device for cutting foodstuffs, in particular for cutting garlic, comprising a first housing part and a second housing part, the first housing part comprising a cutting grid and the second housing part comprising a pressing ram, and comprising a threaded mechanism, by means of which, by rotation of the first housing part in one direction of rotation relative to the second housing part, the pressing ram is movable with respect to the cutting grid, wherein the chopping device has a changeover device which
a. automatically switches the threads of the threaded mechanism into engagement irrespective of the axial relative position of the first housing part relative to the second housing part when the first housing part is rotated in the direction of rotation relative to the second housing part, and/or which
b. automatically switches the threads of the threaded mechanism out of engagement irrespective of the axial relative position of the first housing part relative to the second housing part when the first housing part is rotated in the counter direction of rotation, which is opposed to the direction of rotation, relative to the second housing part.

2. The chopping device as claimed in claim 1, wherein
a. a plurality of threaded segments which are distributed in the circumferential direction and are held in a radially movable manner are arranged in the second housing part, and/or wherein
b. a plurality of threaded segments which are distributed in the circumferential direction and are each mounted in a manner movable radially inward counter to a spring force are arranged in the second housing part, and/or wherein
c. a plurality of spring tongues which are distributed in the circumferential direction and each have a threaded segment are arranged in the second housing part, the threaded segments of which spring tongues are movable radially inward in a spring-elastic manner, and/or wherein
d. a plurality of spring tongues which are distributed in the circumferential direction and each have a threaded segment are arranged in the second housing part, the free ends of which spring tongues are movable radially inward in a spring-elastic manner.

3. The chopping device as claimed in claim 2, wherein
a. the changeover device has a plurality of run-on slopes which move the threaded segments radially inward when the first housing part is rotated in the direction of rotation relative to the second housing part, and/or wherein
b. the changeover device has a plurality of run-on slopes which enable a movement of the threaded segments radially outward when the first housing part is rotated in the counter direction of rotation.

4. The chopping device as claimed in claim 3, wherein
a. the run-on slopes are arranged on a changeover ring, and/or wherein
b. the run-on slopes are arranged on a changeover ring which is connected to the second housing part for rotation therewith and/or which is mounted in the second housing part for rotation therewith, and/or wherein
c. the run-on slopes are arranged within the second housing part, and/or wherein
d. the run-on slopes are connected to the second housing part for rotation therewith, at least with respect to torques which act in the axial direction, and/or wherein
e. the run-on slopes are arranged on a changeover ring which is not accessible from the outside.

5. The chopping device as claimed in claim 2, wherein the threaded segments and/or the spring tongues are directly or indirectly connected to the pressing ram for rotation therewith, at least with respect to torques in the axial direction.

6. The chopping device as claimed in claim 2, wherein
a. the threaded segments are mounted within the second housing part so as to be rotatable within a limited angular range, in particular within an angular range of 45 degrees or of 30 degrees, and/or wherein
b. the threaded segments and/or the pressing ram are arranged on a cage for rotation therewith, said cage being mounted within the second housing part so as to be rotatable within a limited angular range, in particular within an angular range of 45 degrees or of 30 degrees.

7. The chopping device as claimed in claim 6, wherein
a. the cage has a plurality of recesses, which are distributed in the circumferential direction, for the threaded segments and/or the spring tongues, and/or wherein
b. the cage has a plurality of recesses, which are distributed in the circumferential direction, in which the threaded segments and/or the free ends of the spring tongues are arranged in a radially movable manner, and/or wherein
c. the threaded segments and/or the spring tongues are connected to the cage for rotation therewith with respect to torques in the axial direction, and/or wherein
d. each spring tongue is fixedly connected at one of the ends thereof to the cage while the other end is movable radially relative to the cage.

8. The chopping device as claimed in claim 1, wherein
a. the pressing ram and/or the cage are connected to a holding ring for rotation therewith, and/or wherein
b. the pressing ram and/or the cage are connected to a holding ring, which is accessible from the outside, for rotation therewith, and/or wherein
c. the cage is of cylindrical design, with a holding ring being fastened to one end of the cage and the pressing ram and/or the spring tongues being fastened to the other end.

9. The chopping device as claimed in claim 1, wherein, in the engaged position of the threaded mechanism, the threaded segments are in engagement with a mating thread of the threaded mechanism and, in the disengaged position of the threaded mechanism, are spaced apart from the mating thread of the threaded mechanism.

10. The chopping device as claimed in claim 9, wherein
a. the first housing part has the mating thread of the threaded mechanism, or wherein
b. the first housing part has the mating thread which is arranged on the outer side of the first housing part and is designed as an external thread.

11. The chopping device as claimed in claim 1, which comprises a cutting material receptacle which is mounted rotatably in the first housing part and into which the pressing ram can be introduced.

12. The chopping device as claimed in claim 11, wherein
a. the cutting grid is fastened non-releasably to the cutting material receptacle, and wherein the cutting material receptacle has an opening for the pressing ram opposite the cutting grid, or wherein
b. the cutting grid is fastened to the cutting material receptacle so as to be releasable without destruction and/or without a tool, and wherein the cutting material receptacle has an opening for the pressing ram opposite the cutting grid.

13. The chopping device as claimed in claim 1, wherein
a. the pressing ram has an outer contour deviating from the circular shape, in a cross section perpendicular to the axial direction, and/or wherein
b. the pressing ram has an outer contour deviating from the circular shape, in a cross section perpendicular to the axial direction, and the cutting material receptacle has a complementary inner contour, in a cross section perpendicular to the axial direction.

14. The chopping device as claimed in claim 11, wherein the pressing ram, at the free end thereof, has a plurality of pressing projections which can be introduced into the intermediate spaces between the cutting blades of the cutting grid, and wherein a cleaning grid is mounted between the pressing projections so as to be axially displaceable counter to the force of a spring device, said cleaning grid having at least one stop which projects radially beyond the outer contour of the pressing ram, strikes against a counter stop of the cutting material receptacle and keeps the cleaning grid at a distance from the cutting blades of the cutting grid when the pressing projections enter the intermediate spaces between the cutting blades of the cutting grid.

15. The chopping device as claimed in claim 11, wherein the rotational resistance for switching over from the engaged position of the threaded mechanism into the disengaged position and/or the rotational resistance for switching over from the disengaged position of the threaded mechanism into the engaged position is smaller than the rotational resistance for rotating the cutting material receptacle relative to the first housing part.

16. The chopping device as claimed in claim 1, wherein the first housing part has a radially oriented severing blade adjacent to the cutting grid.

17. The chopping device as claimed in claim 1, which comprises a collecting container which can be fixed on the first housing part and/or which can be at least partially introduced into the first housing part.
